(19) United States
(12) Patent Application Publication
(10) Pub. No.: US 2010/0224685 A1
(43) Pub. Date: Sep. 9, 2010

(54) IC CARD CAPABLE OF COMMUNICATING WITH EXTERNAL DEVICE BY UTILIZING ELECTROMAGNETIC INDUCTION

(75) Inventor: Yutaka AOKI, Ome-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Casio Computer Co., Ltd., Tokyo (JP)

(21) Appl. No.: 12/715,607

(22) Filed: Mar. 2, 2010

(30) Foreign Application Priority Data
Mar. 3, 2009 (JP) 2009-048731

(51) Int. Cl. G06K 19/077

(52) U.S. Cl. 235/488; 235/492

(57) ABSTRACT

An IC card includes a card main body, a first antenna which is provided on an upper surface of the card main body along an outer peripheral side surface of the card main body, a semiconductor chip which is arranged on an inner side of the first antenna, and a second antenna which is provided on the inner side of the first antenna. The semiconductor chip has transmission and reception circuits and external connection electrodes connected with the transmission and reception circuits. The second antenna is connected with the external connection electrodes of the semiconductor chip.

### CROSS-REFERENCE TO RELATED APPLICATIONS

This application is based upon and claims the benefit of priority from prior Japanese Patent Application No. 2009-048731, filed Mar. 3, 2009, the entire contents of which are incorporated herein by reference.

### BACKGROUND OF THE INVENTION

1. Field of the Invention

The present invention relates to an IC card.

2. Description of the Related Art

An IC (Integrated Circuit) card incorporating an integrated circuit (an IC) that receives electric waves carried from an external device such as a reader/writer to transmit/receive information held in a memory unit of a built-in semiconductor chip has becomes widespread. As such a card, there is generally an RF-ID (Radio Frequency Identification) card, an IC card having a credit function, a card called an intelligent card, or an ID tag that provides merchandize information for checking out in transport facilities or distribution systems.

Each of these cards has a built-in resonance circuit including an antenna coil and a capacitive element to resonate with received electric waves, and it exchanges information with an external device by using electromotive formed induced by electromagnetic coupling.

As the antenna coil, one that is wound around peripheral side portion of a planar rectangular card for a plurality of turns to be connected with external connection electrodes of a semiconductor chip is known (e.g., JP-A 2006-148462 (KOKAI)). In this case, the antenna coil adopts a configuration that it is extended from one end portion connected with one external connection electrode of the semiconductor chip, spirally turned on the peripheral portion of the card from the inner side toward the outer side for a plurality of number of times, and connected with the other electrode of the semiconductor chip at the other end portion while traversing turned wire paths.

As described above, in JP-A 2006-148462 (KOKAI), since the antenna coil is rounded between the pair of external connection electrodes of the semiconductor chip for a plurality of number of times and traverses the rounded wire path, an insulating film must be provided on this portion traversing the wire paths and a via hole piercing the insulating film in a thickness direction must be provided.

Such a configuration is complicated, not only the number of processing steps is increased, but also a failure such as short circuit is apt to occur. Further, usually, although a card can easily bend since it is as thin as 1 mm or below, providing the via hole further facilitates bending, whereby the reliability cannot be obtained. For example, a break in wirings or breakage of the card itself occurs. The most common cause of card failures is imperfect contact between the IC and wirings, and even slight deformation due to an external pressure leads to a break in wirings. When the card is bent to break a loop portion in this manner, a magnetic flux cannot pass through the loop, thereby disabling communication.

### BRIEF SUMMARY OF THE INVENTION

An object of the present invention is to provide an IC card in which a break in antenna coil hardly occurs and the reliability is improved

An IC card according to an aspect of the present invention comprises: a card main body; a first antenna which is provided on an upper surface of the card main body along an outer peripheral side surface of the card main body; a semiconductor chip which is arranged on an inner side of the first antenna and has transmission and reception circuits and external connection electrodes connected with the transmission and reception circuits; and a second antenna which is provided on the inner side of the first antenna and connected with the external connection electrodes of the semiconductor chip.

Advantages of the invention will be set forth in the description which follows, and in part will be obvious from the description, or may be learned by practice of the invention. The advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a plan view of an IC card as a first embodiment according to the present invention;

FIG. 2 is a cross-sectional view of the IC card taken along a line II-II depicted in FIG. 1;

FIG. 3 is an enlarged cross sectional view of a primary part in FIG. 2;

FIG. 4 is a cross-sectional view of a semiconductor chip as Modification 1 of the first embodiment;

FIG. 5 is a view for explaining a configuration of a circuit in FIG. 5;

FIG. 6 is a view for explaining a circuit operation in FIG. 5;

FIG. 7 is a cross-sectional view of an IC card as Modification 2 of the first embodiment;

FIG. 8 is a cross-sectional view of an IC card as Modification 3 of the first embodiment;

FIG. 9 is a plan view of an IC card as a second embodiment according to the present invention;

FIG. 10 is a cross-sectional view taken along a line X-X in FIG. 9;

FIG. 11 is an enlarged cross-sectional view for explaining a manufacturing method for the IC card as the second embodiment;

FIG. 12 is a cross-sectional view of a step following FIG. 11;

FIG. 13 is a cross-sectional view of a step following FIG. 12; and

FIG. 14 is a cross-sectional view showing a modification of the second embodiment according to the present invention; and

FIG. 15 is a plan view of an IC card as another modification according to the present invention.

### DETAILED DESCRIPTION OF THE INVENTION

### First Embodiment

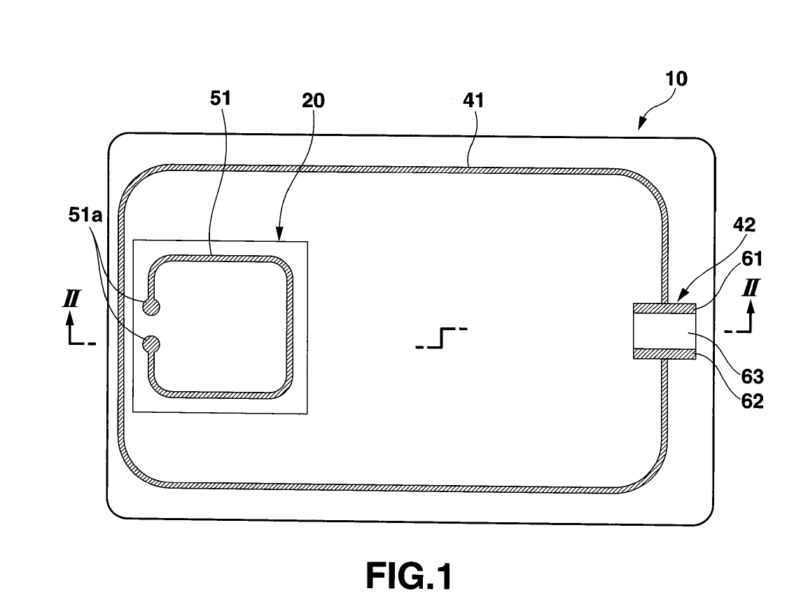

FIG. 1 is a plan view of an IC card as a first embodiment of the present invention. An IC card (which will be referred to as a card hereinafter in this specification) 10, which has a substantially rectangular plane, includes an outer peripheral loop antenna 41 that makes a circuit along an outer peripheral side portion of the rectangular shape, a capacitive element 42, a semiconductor chip 20, and an inner peripheral loop antenna 51 connected with external connection electrodes of the semiconductor chip 20.

The outer peripheral loop antenna 41 wholly has a substantially rectangular shape with circular corner portions, makes a circuit along the outer peripheral side portion of the IC card 10. Although it is not limited, the IC card 10 is formed of copper or aluminum. It can be also formed of gold or silver. The outer peripheral loop antenna 41 has a pair of electrode portions 61 and 62.

A high-dielectric layer 63 is provided between the electrode portions 61 and 62. The electrode portions 61 and 62 and the high-dielectric layer 63 constitute the capacitive element 42. Although the outer peripheral loop antenna 41 wholly has the substantially rectangular shape with the circular corner portions, it is not limited to this shape, and it may have an elliptic shape, a circular shape, or a polygonal shape.

Although described later in detail, the semiconductor chip 20 has integrated circuit units such as a transmission circuit, a reception circuit, a control circuit, a memory unit, and others, and also has external connection electrodes to electrically connect the integrated circuit units with an external device.

The inner peripheral loop antenna 51 has a pair of end portions 51a and 51a joined to upper surfaces of the external connection electrodes of the semiconductor chip 20, and it is drawn out in a direction to detour the pair of end portions 51a and 51a and substantially makes a circuit on the inner side of the outer peripheral side portion of the semiconductor chip 20 in parallel to this portion. The inner peripheral loop antenna 51 wholly has a substantially square or rectangular shape with circular corner portions. Although not limited, this antenna 51 is formed of copper or aluminum. It can be also formed of gold or silver. Although the inner peripheral loop antenna 51 wholly has the substantially square or rectangular shape, it is not limited to this shape in particular, and it may have an elliptic shape, a circular shape, or a polygonal shape.

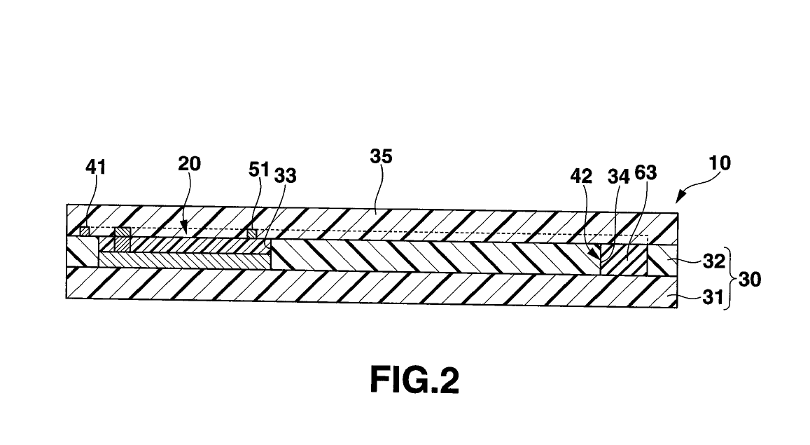

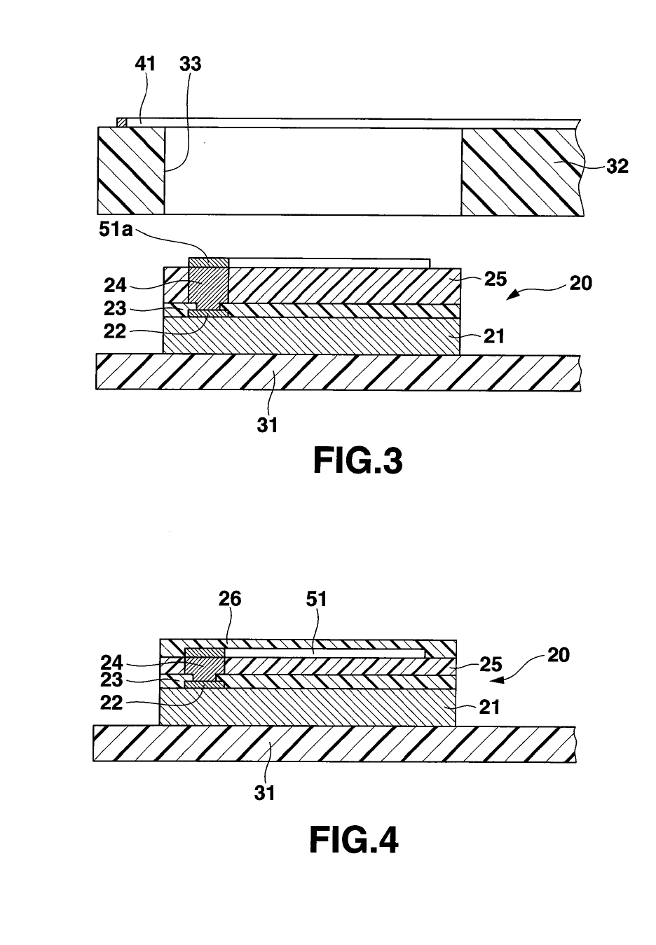

FIG. 2 is a cross-sectional view taken along a line II-II in FIG. 1, and FIG. 3 is an enlarged cross-sectional view for explaining the detail of a primary part in FIG. 3.

The IC card 10 has a card main body 30 and an upper surface sheet 35 bonded to the upper surface of the card main body 30. An entire thickness of the card main body 30 is 800 μm to 1 mm, and the card main body 30 is constituted of a base sheet 31 and an intermediate sheet 32 bonded to the base sheet 31 through an adhesive or a double-faced adhesive sheet. Each of the base sheet 31 and the intermediate sheet 32 is formed of a resin sheet made of, e.g., polyester, polyimide, polyvinyl chloride (PVC), acrylonitrile butadiene styrene (ABS), or polyethylene terephthalate (PET).

The base sheet 31 is a sheet member which typically has a thickness of 100 μm to 250 μm and is entirely flat. The intermediate sheet 32 has a thickness of 300 μm to 600 μm and has an accommodating portion 33 that accommodates the semiconductor chip 20. As shown in FIG. 3, the accommodating portion 33 has a planar size that is substantially equal to or slightly larger than that of the semiconductor chip 20, and it serves as an opening portion piercing in the thickness direction of the base sheet 31. Further, an opening portion 34 for forming the capacitive element 42 is formed in the intermediate sheet 32, and the opening portion 34 is filled with the electrode portions 61 and 62 and the high-dielectric layer 63 having substantially the same thickness as that of the intermediate sheet 32.

The outer peripheral loop antenna 41 is provided on the upper surface of the intermediate sheet 32. Although not shown, the pair of electrode portions 61 and 62 of the outer peripheral loop antenna 41 are also flatly formed on a pair of opposed side surfaces of the opening portion 34 in the intermediate sheet 32. In other words, they are extended in the thickness direction in the opening portion 34.

That is, each of the electrode portions 61 and 62 has a length which is equal to the thickness of the high-dielectric layer 63 in the thickness direction of the intermediate sheet 32. As described above, the pair of electrode portions 61 and 62 and the high-dielectric layer 63 constitute the capacitive element 42.

An efficient method for forming such an intermediate sheet 32 having the outer peripheral loop antenna 41 and the capacitive element 42 fixed thereto will now be exemplified.

First, the opening portion serving as the accommodating portion 33 of the semiconductor chip 20 and the opening portion 34 for forming the capacitive element 42 are provided in the flat resin sheet, thereby forming the intermediate sheet 32. The opening portions may be formed based on a press method or an etching method.

Then, an underlying metal film is formed on an upper surface of the intermediate sheet 32 and in the opening portion 34 by electroless deposition or sputtering, and electrolytic plating is subsequently carried out to form an upper metal film. Then, a photolithography technology is used for etching the upper metal film and the underlying metal film, thereby forming the outer peripheral loop antenna 41 and the pair of electrode portions 61 and 62.

Thereafter, the opening portion 34 can be filled with the high-dielectric layer 63 by a print process or the like to form the capacitive element 42. It is to be noted that the method for filling the opening portion 34 with the high-dielectric layer 63 may be substituted by a method for inserting a regular chip capacitor having electrodes into the opening portion 34 in this case.

In the accommodating portion 33 of the intermediate sheet 32, the semiconductor chip 20 is bonded and fixed to the base sheet 31 by a non-illustrated adhesive. As shown in FIG. 3, the semiconductor chip 20 is formed of, e.g., silicon, and it has a semiconductor substrate 21 having an integrated circuit formed on an upper surface side, connection pads 22 connected with the integrated circuit of the semiconductor substrate 21, a protective film 23 that covers the upper surface of the semiconductor substrate 21 except a part of the connection pad 22, projection electrodes (external connection electrodes) 24 formed on the connection pad 22, and an insulating film 25 formed on the protective film 23 around the projection electrodes (the external connection electrodes) 24 as will be described later.

Regular wirings have a thickness of approximately 10 μm or below, whereas the projection electrodes (the external connection electrodes) 24 have a large thickness (a height) of 30 μm to 80 μm, and its upper surface is level with an upper surface of the insulating film 25. The inner peripheral loop antenna 51 is provided on the upper surface side of the semiconductor chip 20. That is, the pair of end portions 51a and 51a of the inner peripheral loop antenna 51 are secured to and provided on the upper surface of the insulating film 25 in a state that they are bonded to the upper surfaces of the projection electrodes (the external connection electrodes) 24 of the semiconductor chip 20, and these members are integrated as a semiconductor package as a whole.

A method for forming the inner peripheral loop antenna 51 on the upper side of the semiconductor chip 20 to configure the semiconductor package will now be described. First, an underlying metal film is formed on the entire upper surface of the insulating film 25 of the semiconductor chip 20 including the upper surfaces of the projection electrodes (the external connection electrodes) 24 by the electroless deposition or the sputtering, and then the underlying metal film is used as a plating channel to perform the electrolytic plating, thereby forming the upper metal film. Subsequently, the photolithography technology is utilized to etch the upper metal film and the underlying metal film, thereby forming the inner peripheral loop antenna 51 having the pair of end portions 51a and 51a.

In FIG. 3, when the semiconductor chip 20 is accommodated in the accommodating portion 33 and the lower surface of the intermediate sheet 32 is bonded to the upper surface of the base sheet 31, the outer peripheral loop antenna 41 and the inner peripheral loop antenna 51 are placed on the same plane, i.e., they are level with each other since the thickness of the intermediate sheet 32 is equal to the height of the semiconductor chip 20. In this case, if the outer peripheral loop antenna 41 and the inner peripheral loop antenna 51 have the same thickness, the upper and lower surfaces of both the outer peripheral loop antenna 41 and the inner peripheral loop antenna 51 are level with each other. However, the outer peripheral loop antenna 41 and the inner peripheral loop antenna 51 do not necessarily have the same thickness. Even if both the antennas have different thicknesses, the lower surface of the outer peripheral loop antenna 41 is level with that of the inner peripheral loop antenna 51.

The upper surface sheet 35 is arranged on the upper surfaces of the semiconductor chip 20 and the intermediate sheet 32. The upper surface sheet 35 typically has a thickness of 50 μm to 100 μm, and it is a transparent sheet member having an entire flat surface that is formed of polyester or polyimide and bonded to the upper surface of the semiconductor chip 20 and the entire upper surface of the intermediate sheet 32 through an adhesive or a double-faced adhesive sheet. A surface that is bonded to the semiconductor chip 20 and the intermediate sheet 32 is subjected to exterior printing.

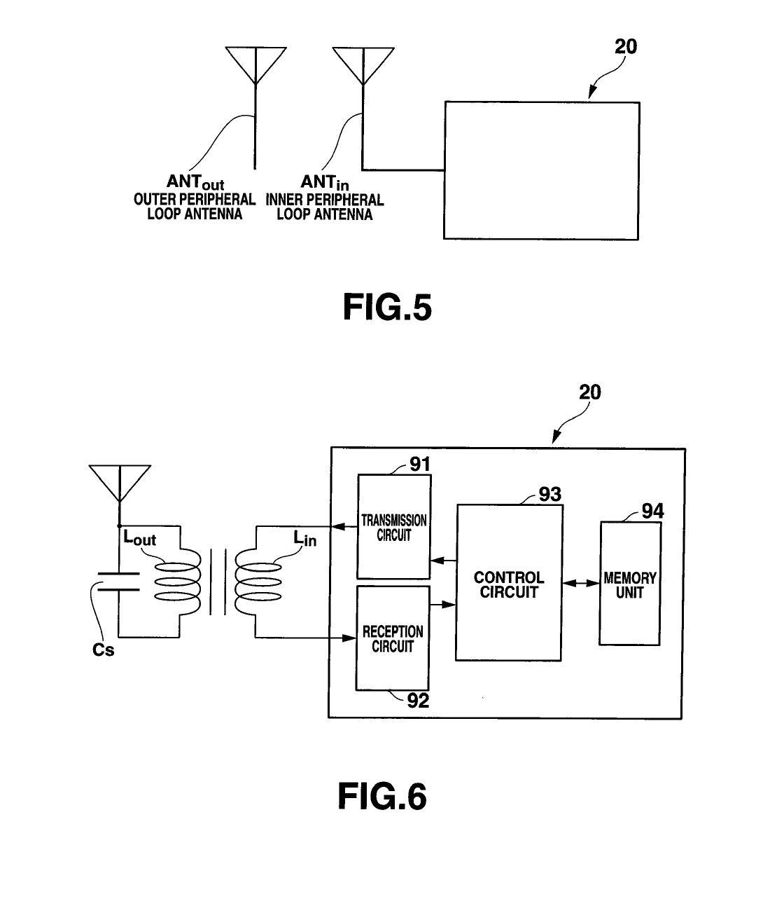

Functions of the outer peripheral loop antenna 41 and the inner peripheral loop antenna 51 will now be described. In FIG. 5, an outer peripheral loop antenna ANTₒᵤₜ and an inner peripheral loop antenna ANTᵢₙ connected with the semiconductor chip 20 are arranged in close proximity to each other. Therefore, the outer peripheral loop antenna ANTₒᵤₜ and the inner peripheral loop antenna ANTᵢₙ are inductively coupled.

As shown in FIG. 6, an electric wave having a carrier frequency fc transmitted from an antenna of an external device such as a non-illustrated reader/writer generates an induced current in a coil Lₒᵤₜ of the IC card 10 by electromagnetic induction. The induced current generated in the coil-Lₒᵤₜ produces an induced current in an electromagnetically coupled coil Lᵢₙ. The coil Lₒᵤₜ and a capacitance Cₛ constitute a resonance circuit, and matching its resonance frequency f₀ with the carrier frequency fc results in generating a large resonance current in the coil Lₒᵤₜ.

The semiconductor chip 20 has integrated circuits constituting a transmission circuit 91, a reception circuit 92, a control circuit 93 and a memory unit 94, respectively. The control circuit 93 is driven by the induced current generated in the coil Lᵢₙ. As a result, data is restored from the electric wave received by the outer peripheral loop antenna 41, and the memory unit 94 is accessed. The control circuit 93 writes data into the memory unit 94, or reads and modulates data stored in the memory unit 94 to the transmission circuit 91, and transmits the modulated data to an external device through the coil Lₒᵤₜ. The external device indicates in a display unit information which is held in the memory unit 94 of the semiconductor chip 20 and transmitted from the transmission circuit. In this manner, information is exchanged between the external device and the IC card 10.

FIG. 4 shows Modification 1 of the first embodiment. In the semiconductor package shown in FIG. 3, the inner loop antenna 51 is provided to be exposed on the upper surface of the semiconductor chip 20. Modification 1 shows a configuration in which the inner peripheral loop antenna 51 is embedded in the insulating film.

That is, in the example shown in FIG. 4, an upper layer insulating film 26 is provided on the upper surface of the inner peripheral loop antenna 51 and the entire upper surface of the insulating film 25. In this case, a height of the projection electrodes (the external connection electrodes) 24 and a thickness of the insulating film 25 are reduced for a thickness of the upper layer insulating film 26. According to the semiconductor package having such a configuration, the junction of the semiconductor chip 20 and the inner peripheral loop antenna 51 becomes stronger.

As described above, it is desirable to form the semiconductor chip 20 having the inner peripheral loop antenna 51 as the semiconductor package. In particular, as a manufacturing method for efficiently obtaining such a package, the semiconductor chip 20 having the inner peripheral loop antenna 51 depicted in FIG. 3 or 4 is formed in accordance with each semiconductor chip forming region in a semiconductor wafer state, and then dicing is performed along a dicing line to obtain each semiconductor package, thereby improving productivity.

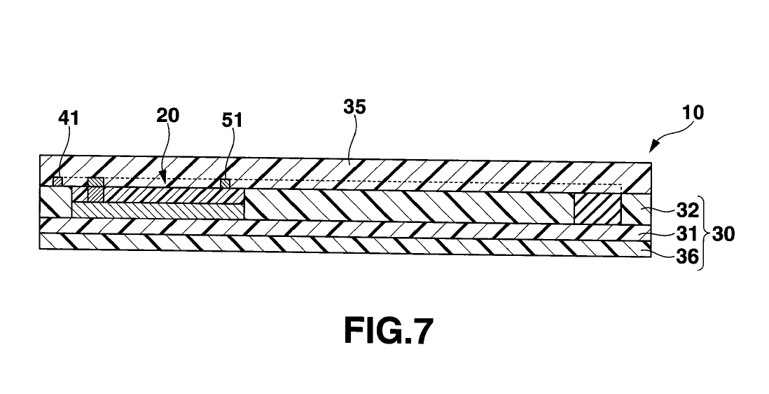

FIG. 7 shows Modification 2 of the first embodiment. In this Modification 2, a lower surface sheet 36 is added to the card main body 30. The lower surface sheet 36 is formed of a transparent resin sheet like the upper surface sheet 35, its surface facing the base sheet 31 is subjected to exterior printing, and this printed surface is bonded to the lower surface of the base sheet 31.

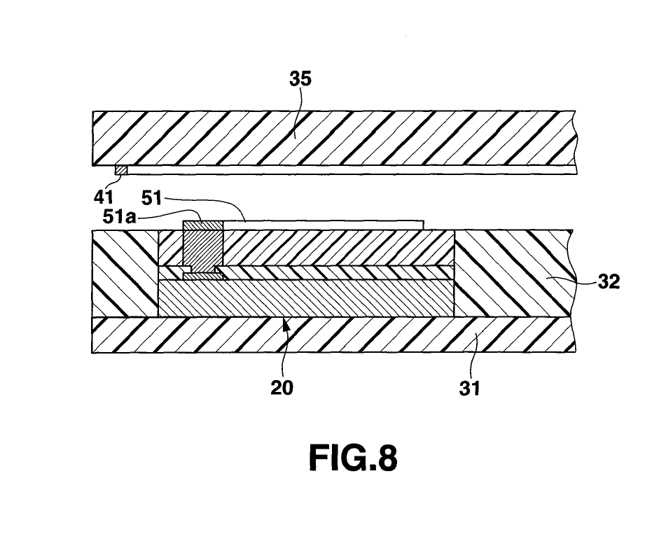

FIG. 8 shows Modification 3 of the first embodiment. In the examples shown in FIGS. 3 and 4, the outer peripheral loop antenna 41 is provided on the upper surface of the intermediate sheet 32. In FIG. 8, the outer peripheral loop antenna 41 is provided on the lower surface of the upper surface sheet 35. Since the upper surface sheet 35 is bonded to the upper surface of the intermediate sheet 32 through an adhesive or a double-faced adhesive sheet, the outer peripheral loop antenna 41 is level with the inner peripheral loop antenna 51.

As explained above, although a connector such as a coaxial cable must be interposed between the end portions 51a and the outer peripheral loop antenna 41 in the conventional example, a rewiring of the semiconductor chip 20 is the inner peripheral loop antenna 51 in the IC card 10 according to the first embodiment, and hence the wire connection between the end portions 51a and the outer peripheral loop antenna 41 can be eliminated. That is, the outer peripheral loop antenna 41 is turned along the inner side of the outer peripheral side portion of the card main body 30, the semiconductor chip 20 having the built-in transmission/reception circuits is arranged on the inner side of the outer peripheral loop antenna 41, and the inner peripheral loop antenna 51 turned along the outer peripheral side portion of the semiconductor chip 20 is arranged on the upper surface of the semiconductor chip 20, whereby each loop antenna does not get across a wire path of the antenna itself, thus improving the reliability. Further, since the outer peripheral loop antenna 41 is level with the inner peripheral loop antenna 51, an efficiency of the electromotive force generated by electromagnetic coupling is high, and the reliable operation can be obtained.

### Second Embodiment

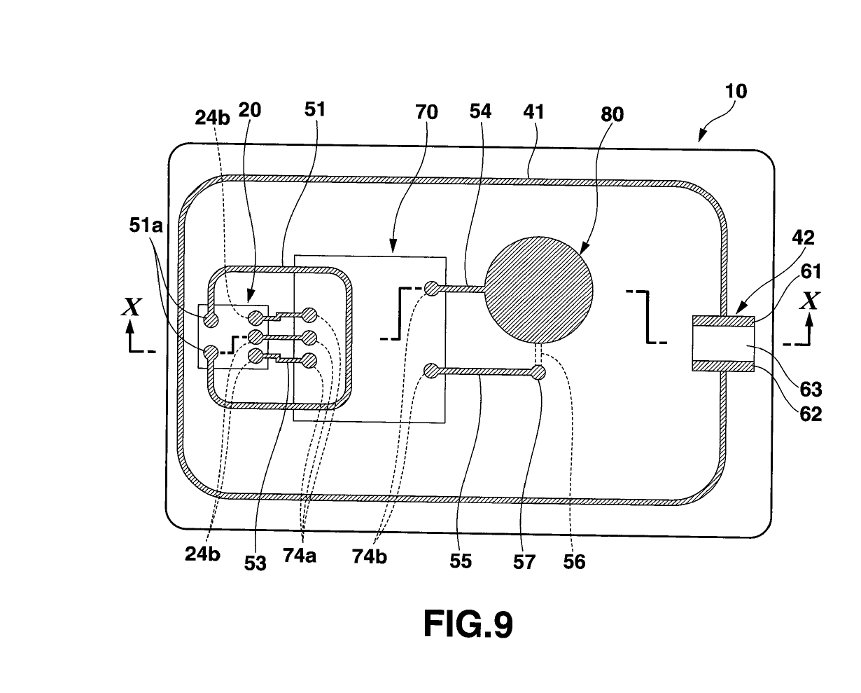

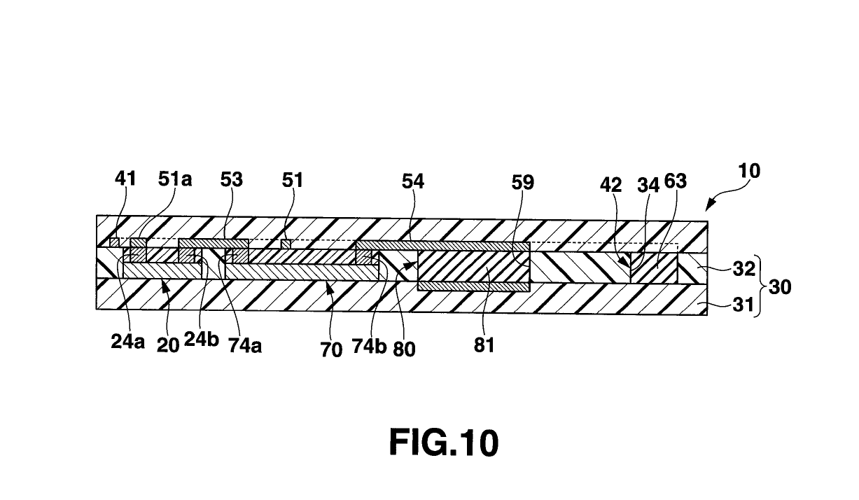

FIG. 9 is a plan view of an IC card according to a second embodiment of the present invention. FIG. 10 is a cross-sectional view taken along a line X-X in FIG. 9. An IC card (which will be referred to as a card hereinafter) 10 has a substantially rectangular plane, and it includes an outer peripheral loop antenna 41 that makes a circuit along an outer peripheral side portion of the rectangular shape, a capacitive element 42, a first semiconductor chip 20, a second semiconductor chip 70, an inner peripheral loop antenna 51 connected with external connection electrodes of the first semiconductor chip 20, and a power supply battery 80.

The capacitive element 42 is connected with a middle part of a wire path forming the loop antenna in the outer peripheral loop antenna 41 like the first embodiment.

The semiconductor chip 20 is formed to have a smaller plane size than that in the first embodiment, but it has integrated circuits such as a transmission circuit, a reception circuit, a control circuit, a memory unit and others like the first embodiment and also has a plurality of projection electrodes (external connection electrodes) 24a and 24b for electrically connecting the integrated circuit units to an external device.

Although not shown, the second semiconductor chip 70 has a control circuit for system control, an arithmetic unit, and a memory unit. The second semiconductor chip 70 has a plurality of input/output electrodes 74a connected with the projection electrodes (the external connection electrodes) 24b of the first semiconductor chip 20 through wirings 53 and a plurality of power supply electrodes 74b.

The inner peripheral loop antenna 51 has a pair of end portions 51a and 51a joined to upper surfaces of the external connection electrodes of the first semiconductor chip 20, and it is drawn out in a direction apart from the pair of end portions 51a and 51a and extended to be turned and to make substantially one circuit on an upper surface of an intermediate sheet 32 and an upper surface of the second semiconductor chip 70.

As described above, in the second embodiment, since a plane size of the inner peripheral loop antenna 51 is larger than that of the first semiconductor chip 20, sufficient electromotive force generated by electromagnetic induction can be provided even if the plane size of the first semiconductor chip 20 is small. This means that the necessary plane size of the inner peripheral loop antenna 51 does not have to be considered when examining the plane size of the first semiconductor chip 20, and the plane size of the first semiconductor chip 20 can be sufficiently reduced. As a result, a price of the first semiconductor chip 20 can be reduced, whereby a price of the IC card 10 can be decreased.

It is to be noted that the inner peripheral loop antenna 51 is not limited to a rectangular shape in particular in the second embodiment, and it may have an elliptic shape, a circular shape or a polygonal shape.

The power supply battery 80 is formed of, e.g., an electric double layer capacitor. Although not shown, this battery is constituted of a separator arranged in an intermediate portion in a thickness direction, a pair of polarizable electrodes which are provided on upper and lower surfaces of the separator and formed of a activated carbon or the like, and a package that is filled with an electrolytic solution and covers the pair of polarizable electrodes and the separator. In regard to the detail of the electric double layer capacitor, please refer to, e.g., JP-A 2000-353542 (KOKAI).

One of positive and negative electrodes of the power supply battery 80 is connected with one of the power supply electrodes 74b of the second semiconductor chip 70 through a wiring 54 provided on the upper surface of the intermediate sheet 32 and the upper surface of the second semiconductor chip 70. Furthermore, the other of the positive and negative electrodes of the power supply battery 80 is connected with the other one of the power supply electrodes 74b of the second semiconductor chip 70 through a wiring 56 formed on the lower surface of the intermediate sheet 32, a via hole 57 (see FIG. 9) formed in the intermediate sheet 32, and a wiring 55 provided on the upper surface of the intermediate sheet 32 and the upper surface of the semiconductor chip 70.

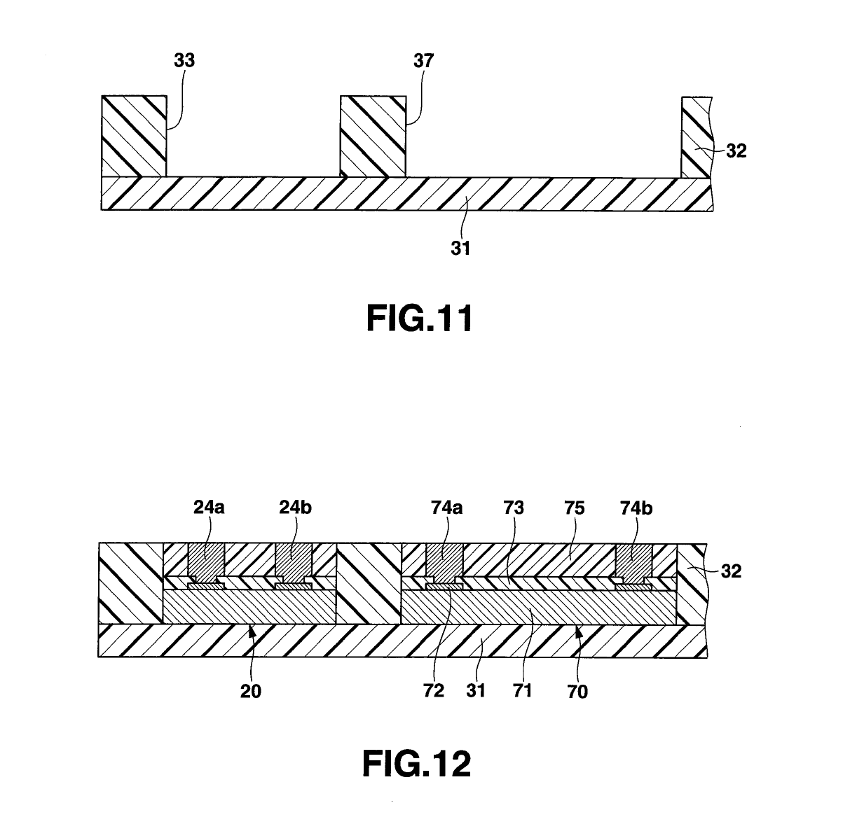

FIGS. 11 to 13 are enlarged cross-sectional views for explaining a primary part in the second embodiment and a manufacturing method thereof.

The intermediate sheet 32 has a first accommodating portion 33 that accommodates the first semiconductor chip 20 and a second accommodating portion 37 that accommodates the second semiconductor chip 70, and it is bonded to the upper surface of the base sheet 31 through an adhesive or a double-faced adhesive sheet after forming the first accommodating portion 33 and the second accommodating portion 37 to a flat sheet member by a press method or an etching method (see FIG. 11).

The first semiconductor chip 20 and the second semiconductor chip 70 are accommodated in the first accommodating portion 33 and the second semiconductor portion 37, respectively, and each bottom surface is bonded to the base sheet 31. The second semiconductor chip 70 is formed of, e.g., silicon like the first semiconductor chip 20, and it has a semiconductor substrate 71 having integrated circuits formed on an upper surface side, a connection pad 72 connected with the integrated circuits of the semiconductor substrate 71, a protective film 73 that covers an upper surface of the semiconductor substrate 71 except a part of the connection pad 72, a plurality of input/output electrodes 74a and a pair of power supply electrodes 74b formed on the connection pad 72, and an insulating film 75 formed on the protective film 73 around the input/output electrodes 74a and the power supply electrodes 74b (see FIG. 12).

The outer peripheral loop antenna 41 and the inner peripheral loop antenna 51 are provided on the upper surface of the intermediate sheet 32. The inner peripheral loop antenna 51 is drawn out in a direction along which it gets away from the pair of end portions 51a and 51a joined to the upper surfaces of the projection electrodes (the external connection electrodes) 24 of the first semiconductor chip 20 to be turned on the upper surface of the intermediate sheet 32 and the upper surface of the second semiconductor chip 70.

Further, the wirings 53 connecting the plurality of projection electrodes (the external connection electrodes) 24b of the first semiconductor chip 20 with the plurality of input/output electrodes 74a of the second semiconductor chip 70 are formed on the upper surface of the semiconductor chip 20, the upper surface of the semiconductor chip 70, and the upper surface of the intermediate sheet 32, respectively.

Furthermore, the wiring 54 that connects one of the positive and negative electrodes of the power supply battery 80 with one of the power supply electrodes 74b of the second semiconductor chip 70 is provided on the upper surface of the intermediate sheet 32 and the upper surface of the second semiconductor chip 70.

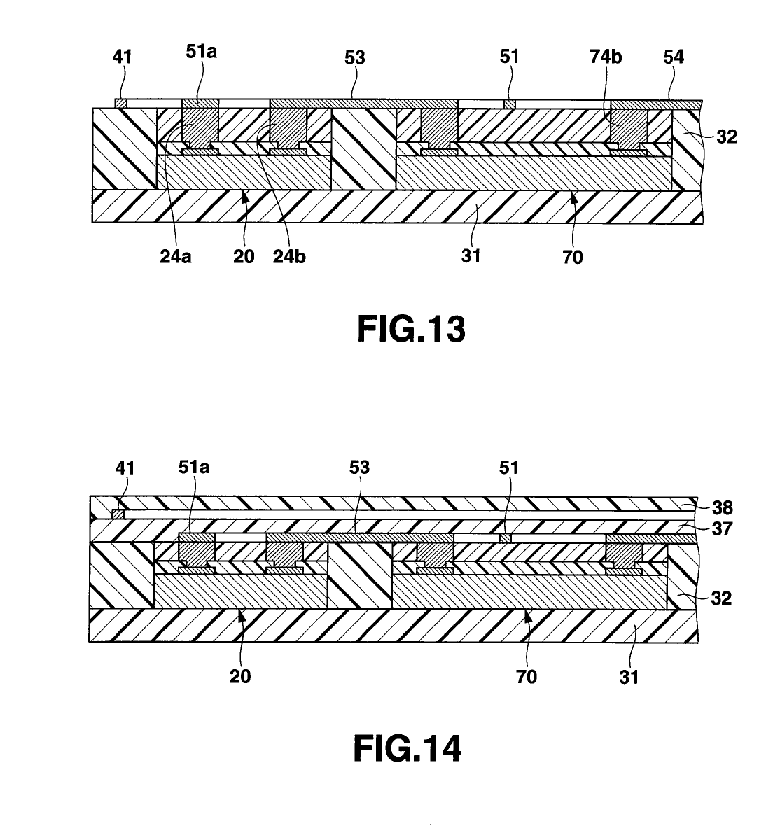

An efficient method for forming the outer peripheral loop antenna 41, the inner peripheral loop antenna 51 and the capacitive element 42 on the intermediate sheet 32 will now be described with reference to FIG. 13. However, in regard to portions concerning the power supply battery 80 and the capacitive element 42, please refer to FIG. 10.

First, the first accommodating portion 33 which accommodates the first semiconductor chip 20, the second accommodating portion 37 which accommodates the second semiconductor chip 70, a third accommodating portion 59 which accommodates the power supply battery 80, and a an opening portion 34 in which the capacitive element 42 is formed are provided in a flat resin sheet, thereby forming the intermediate sheet 32. Then, although not shown, a via hole 57 and the wiring 56 on the lower surface of the intermediate sheet 32 are formed. The via hole 57 can be formed by using a punching method or an etching method, and the wiring 56 can be formed by using a photolithography technology.

Then, the first semiconductor chip 20, the second semiconductor chip 70, and the power supply battery 80 are accommodated in the first accommodating portion 33, the second accommodating portion 37, and the third accommodating portion 59 to be bonded to the base sheet 31, respectively.

An underlying metal film is formed on the entire upper sheet of the intermediate sheet 32 and in the opening portion 34 by electroless deposition or sputtering, and then electrolytic plating using the underlying metal film as a plating channel is carried out to form an upper metal film. Subsequently, the photolithography technology is utilized to etch the upper metal film and the lower metal film, thereby forming the outer peripheral loop antenna 41 including the pair of electrode portions 61 and 62, the inner peripheral loop antenna 51, the plurality of wirings 53 and the pair of wirings 54. Thereafter, a high-dielectric layer 63 can be formed in the opening portion 34.

As described above, in the IC card 10 according to the second embodiment, since the semiconductor chip 20 having the built-in transmission and reception circuits is arranged on the inner side of the outer peripheral loop antenna 41 and the inner peripheral loop antenna 51 is provided on the upper surface of the intermediate sheet 32 including the upper surface of the semiconductor chip 20, the respective loop antennas do not traverse the wire paths of the antenna themselves, and the reliability can be improved.

FIG. 14 shows a modification of the second embodiment. In FIG. 14, a point different from the card depicted in FIG. 10 lies in that an outer peripheral loop antenna 41 is formed on an upper insulating layer 38 formed on an inner loop antenna 51.

That is, an IC card 10 depicted in FIG. 14 has a configuration that an upper insulating layer 38 is formed on an entire upper surface of an intermediate sheet 32 including a wiring 53 and upper surfaces of an inner peripheral loop antenna 51 and others, an outer peripheral loop antenna 41 is formed on the upper insulating layer 38, and an overcoat film 39 is formed on an entire upper surface of the upper insulating layer 38 including an upper surface of the outer peripheral loop antenna 41.

In the present invention, modifications except those explained above can be applied. For example, in the configuration depicted in FIG. 14, the outer peripheral loop antenna 41 and the overcoat film 39 are not formed but the outer peripheral loop antenna 41 may be formed on a lower surface of an upper surface sheet 35 as depicted in FIG. 8. Furthermore, in the configuration depicted in FIG. 13, the upper insulating layer 38 may be formed on the upper surface of the intermediate sheet 32 including the upper surfaces of the outer peripheral loop antenna 41, the inner peripheral loop antenna 51 and others and the upper surface sheet 35 may be bonded to the upper surface of the upper insulating layer 38.

As the semiconductor chip, it is possible to adopt a configuration that the upper insulating layer is formed on the upper surface of the intermediate sheet 32 including the upper surfaces of the inner peripheral loop antenna 51 and others even in the IC card 10 having the semiconductor chip 20 shown in FIG. 8 alone.

Moreover, the second embodiment can adopt a configuration that the lower surface sheet 36 is bonded to the lower surface of the base sheet 31. Additionally, although not shown, the card main body 30 may be formed of one plate-like member, and each accommodating portion which accommodates the semiconductor chip or the like may be formed as a concave portion having a bottom surface at a middle part in the thickness of the plate-like member.

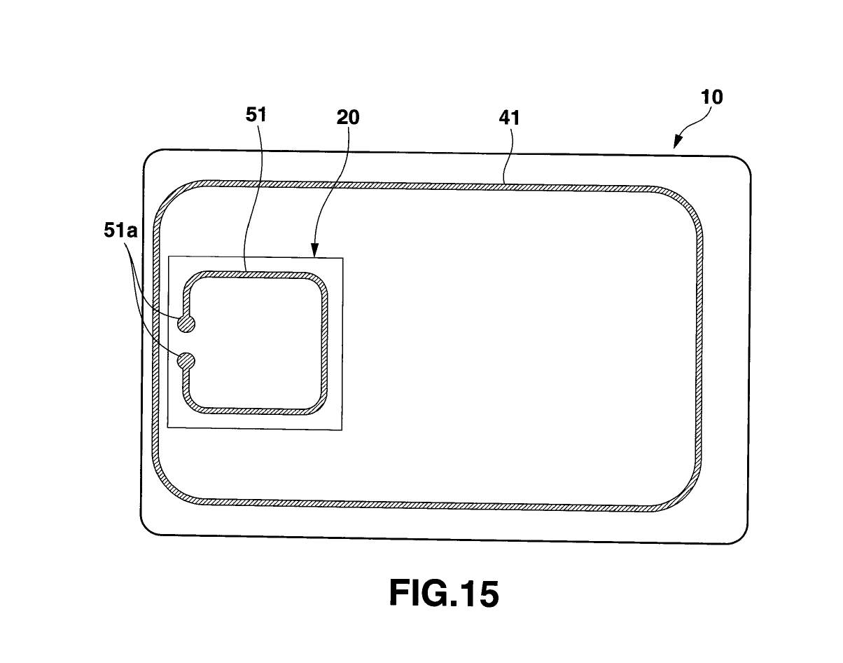

It is to be noted that FIG. 15 is a plan view of an IC card in another modification of the present invention. A configuration which does not have a capacitive element 42 may be adopted in this manner.

Besides, the present invention can be modified and applied in many ways within the scope of the invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An IC card comprising:
a card main body;
a first antenna which is provided on an upper surface of the card main body along an outer peripheral side surface of the card main body;
a semiconductor chip which is arranged on an inner side of the first antenna and has transmission and reception circuits and external connection electrodes connected with the transmission and reception circuits; and
a second antenna which is provided on the inner side of the first antenna and connected with the external connection electrodes of the semiconductor chip.

2. The IC card according to claim 1, wherein the first antenna comprises an outer peripheral loop antenna and the second antenna comprises an inner peripheral loop antenna arranged on an inner side of the first antenna.

3. The IC card according to claim 1, further comprising a capacitive element connected with the first antenna.

4. The IC card according to claim 2, wherein the semiconductor chip has an insulating film that covers an upper surface on which the transmission and reception circuits are formed, and at least a part of the inner peripheral loop antenna is provided on the insulating film.

5. The IC card according to claim 4, wherein a plane size of the inner peripheral loop antenna is smaller than a plane size of the semiconductor chip, and the entire inner peripheral loop antenna is provided on the insulating film of the semiconductor chip.

6. The IC card according to claim 5, wherein the external connection electrodes is level with the insulating film.

7. The IC card according to claim 6, wherein the inner peripheral loop antenna has end portions joined to upper surfaces of the external connection electrodes.

8. The IC card according to claim 7, wherein the upper surface of the card main body is level with an upper surface of the insulating film of the semiconductor chip, and the outer peripheral loop antenna is provided on the upper surface of the card main body.

9. The IC cared according to claim 8, wherein the card main body includes a base sheet and an intermediate sheet having an accommodating portion which accommodates the semiconductor chip.

10. The IC card according to claim 9, further comprising an upper surface sheet provided on the upper surface of the card main body.

11. The IC card according to claim 5, wherein an upper layer insulating film which covers the inner peripheral loop antenna is formed on the semiconductor chip.

12. The IC card according to claim 11, wherein the card main body includes a base sheet and an intermediate sheet having an accommodating portion which accommodates the semiconductor chip, and the upper layer insulating film is formed on an upper surface of the intermediate sheet.

13. The IC card according to claim 12, wherein the outer peripheral loop antenna is provided on the upper layer insulating film.

14. The IC card according to claim 4, wherein the card main body includes a base sheet and an intermediate sheet having an accommodating portion which accommodates the semiconductor chip, and the other part of the inner peripheral loop antenna is provided on an upper surface of the intermediate sheet.

15. The IC card according to claim 14, wherein the outer peripheral loop antenna is provided on the upper surface of the intermediate sheet.

16. The IC card according to claim 14, further comprising an upper surface sheet which covers the intermediate sheet, wherein the outer peripheral loop antenna is provided on the upper surface sheet.

17. The IC card according to claim 14, further comprising an additional semiconductor chip, wherein the card main body has an additional accommodating portion which accommodates the additional semiconductor chip, and the inner peripheral loop antenna is arranged on the additional semiconductor chip accommodated in the additional accommodating portion.

18. The IC card according to claim 17, wherein the additional semiconductor chip has an insulating film formed on an upper surface thereof, and the inner peripheral loop antenna is provided on an upper surface of the insulating film of the additional semiconductor chip.

19. The IC card according to claim 17, comprising wirings which connect the semiconductor chip with the additional semiconductor chip.

20. The IC card according to claim 14, wherein an upper insulating layer is provided on the inner peripheral loop antenna and on the intermediate sheet, and the outer peripheral loop antenna is provided on the upper insulating layer.

21. The IC card according to claim 20, further comprising an additional semiconductor chip, wherein the card main body has an additional accommodating portion which accommodates the additional semiconductor chip, and the inner peripheral loop antenna is arranged on the additional semiconductor chip accommodated in the additional accommodating portion.

22. The IC card according to claim 17, further comprising a power supply battery, wherein the card main body has an accommodating portion which accommodates the power supply battery, and the power supply battery is accommodated in the accommodating portion to be connected with the additional semiconductor chip.

23. The IC card according to claim 22, wherein the power supply battery is an electric double layer capacitor.
